(19) United States
(12) Patent Application Publication
(10) Pub. No.: US 2014/0270143 A1
(43) Pub. Date: Sep. 18, 2014

(54) METHOD AND SYSTEM FOR SERVING CUSTOMERS IN A CONTACT CENTER

(71) Applicant: AVAYA INC., Basking Ridge, NJ (US)

(72) Inventors: Sanjeev Upadhyaya, Pune (IN); Dhaval Desai, Pune (IN)

(73) Assignee: AVAYA INC., Basking Ridge, NJ (US)

(21) Appl. No.: 13/794,906

(22) Filed: Mar. 12, 2013

(51) Int. Cl. H04M 3/523

(52) U.S. Cl. CPC H04M 3/5233
USPC 379/265.12

(57) ABSTRACT

A contact center for processing a work request is provided. The contact center includes a queuing module operable to add a contact of a customer in a first work queue for processing of the work request received. Further, the contact center includes an interactive module to prompt the customer for receiving inputs corresponding to additional skill or an additional work request of the customer, while the customer is waiting in the first work queue for availability of an agent for processing of the work request. Furthermore, the queuing module may add the contact of the customer in a second work queue for serving the customer by processing of at least one of the work request and the additional work request based on the inputs. The customer is served when an agent is available through at least one of the first work queue and the second work queue.

### BACKGROUND

1. Field of the Invention

Embodiments of the present invention generally relate to contact centers and particularly to serving customers in contact center for improving agent utilization and customer satisfaction.

2. Description of Related Art

Contact centers are employed by many enterprises to service inbound and outbound contacts from customers. A typical contact center includes a switch and/or server to receive and route incoming packet-switched and/or circuit-switched contacts and one or more resources, such as human agents and automated resources (e.g., Interactive Voice Response (IVR) units), to service the incoming contacts (customers). Contact centers distribute contacts, whether inbound or outbound, for providing service to any suitable resource according to predefined criteria. In many existing systems, the criteria for serving the contact from the moment that the contact center becomes aware of the contact until the contact is connected to an agent are client or operator-specifiable (i.e., programmable by the operator of the contact center), via a capability called vectoring. Normally in present-day Automatic Call distributors (or ACDs) when the ACD system's controller detects that an agent has become available to handle a contact, the controller identifies all predefined contact-handling queues for the agent (usually in some order of priority) and delivers to the agent the highest-priority, oldest contact that matches the agent's highest-priority queue.

The primary objective of contact center management is to ultimately maximize contact center performance and profitability. That may involve minimizing cost, maximizing contact throughput, and/or maximizing revenue. Further, ongoing challenges in contact center administration involve optimizing contact center efficiency and keeping the contacts satisfied from the service offered by the contact center.

Contact center efficiency is generally measured in two ways that are service level and match rate. Service level is typically determined by dividing the number of contacts accepted within the specified period by the number accepted plus the number that were not accepted, but completed in some other way (e.g., abandoned, given busy, canceled, flowed out). Of course, service level definitions may vary from one enterprise to another.

Further, Match rate is usually determined by dividing the number of contacts accepted by a primary skill level agent within a period of time by the number of contacts accepted by any agent for a queue over the same period. An agent with a primary skill level is one that typically can handle contacts of a certain nature most effectively and/or efficiently. There are other contact center agents that may not be as proficient as the primary skill level agent, and those agents are identified either as secondary skill level agents or backup skill level agents. As can be appreciated, contacts received by a primary skill level agent are typically handled more quickly and accurately or effectively (e.g., higher revenue attained) than a contact received by a secondary or even backup skill level agent. Thus, it is an objective of most contact centers to optimize match rate along with service level.

In addition to service level and match rate performance measures, contact centers use other Key Performance Indicators (“KPIs”), such as revenue, estimated, actual, or predicted wait time, average speed of answer, throughput, agent utilization, agent performance, agent responsiveness and the like, to calculate performance relative to their Service Level Agreements (“SLAs”).

Throughput of a contact center is a measure of the number of calls/contact requests or work requests that can be processed by an agent in a given amount of time. Further, to enhance the throughput, agents' utilization and customer satisfaction are the main factors of the contact center. Agent utilization is a measure of how efficiently agents' time is being used. Customer service level is a measure of the time customers spend waiting for their work to be handled. Company contact center wishes to provide service to as many requests as possible in a given amount of time by minimizing the wait time for their customers.

Typically, when a new work request arrives into a contact center, an agent to work on it is selected according to a type of work request. For example, if the work request of a customer corresponds to one query and includes the customer's choice to converse with an agent in a particular language then as per the current IVR system of a contact center, an agent pool may be identified that can handle the work request of the customer in the particular language of the customer's choice. If all agents of the identified agent pool (of the contact center) are busy then the customer needs to wait until any agent is available to serve him/her.

Due to such scenario, the customer, having the particular work request, may not be satisfied when the customer is forced to wait for availability of an agent who can serve the customer based on the work request of the customer. Further, the contact center may have agents related to other agent pool who may be capable to serve customers for other types of work requests that may be different from the particular work request of the customer. For example, if the customer sends a work request related to investment scheme to the contact center then an agent pool including agents with proficiency in a field related to the investment scheme may be identified so as to serve the customer. Similarly, if the customer provides an initial input regarding a preferred language, such as English then the suitable agents who have proficiency in the investment scheme and know English language may be identified and thereafter the work request of the customer (related to the investment scheme and the customer's choice of English language) may be provided to those suitable agents for serving the customer.

Further, there may be a case that the identified agents (who have proficiency in the field related to the work request of the customer) are busy or not available for serving the customer. On the other hand, the other agent pool may be idle. Thus, the current system of the contact center is not able to distribute the work request appropriately among all the pools of the agents and further, all the agents of the contact center are not utilized properly. Accordingly, this reduces throughput of the contact center.

Based on the aforementioned, a contact center, and corresponding methods and systems are required to overcome existing challenges and to serve customers by improving an agent utilization and customer satisfaction. Thus, the contact center should be able to implement cost effective methods for serving customers.

### SUMMARY

Embodiments in accordance with the present invention provide a method for serving a customer in a contact center having a plurality of agents for a plurality of work queues. The method may include routing a customer call to a first work queue of the plurality of work queues based on a primary work request received from a customer. Further, the method may include receiving an intermediate input from the customer while the customer is waiting in the first work queue for processing of the primary work request, the intermediate input corresponds to at least one of skills and one or more additional work requests of the customer. The method may further include adding the customer call to a second work queue of the plurality of work queues based on the intermediate input from the customer. The customer is served by processing at least one of the primary work request and the one or more additional work requests based on the intermediate input when at least one of the plurality of agents is available through at least one of the first work queue and the second work queue.

Embodiments in accordance with the present invention further provide a contact center that includes a plurality of work queues and a plurality of agents for processing work requests from the plurality of work queues. Further, the contact center may include a queuing module operable to add a contact of a customer in a first work queue of the plurality of work queues for processing of a work request received from the customer. Further, the contact center may include an interactive module to prompt the customer for receiving one or more inputs corresponding to at least one of an additional skill or an additional work request of the customer, while the customer is waiting in the first work queue for availability of an agent for processing of the work request. Furthermore, the queuing module further configured to add the contact of the customer in a second work queue of the plurality of queues for serving the customer by processing of at least one of the work request and the additional work request based on the one or more inputs received from the customer. Herein, the customer is served when at least one agent of the plurality of agents is available through at least one of the first work queue and the second work queue.

Furthermore, embodiments of the present invention provide a method for serving a customer in a contact center having a plurality of work queues. The method may include prompting the customer for receiving one or more inputs corresponding to an additional work request while the customer is waiting for availability of an agent in a first work queue for processing of a primary work request of the customer. Further, the method may include adding a contact of the customer in a second work queue for processing of the additional work request by an agent of the second work queue. Herein, the contact is queued simultaneously in the first work queue and the second work queue. Further, the method may include adding the contact in a priority queue for a time while the customer is being served in the first work queue, and when the contact reaches to a head of the second work queue. The method may further include moving the contact from the priority queue to the second work queue when the customer is served in the first work queue. The contact is moved to the second work queue for serving the customer by processing the additional work request associated with the second work queue.

The present invention can provide a number of advantages that may include allowing customers to be queued in more than one queue while waiting for agent in the first work queue. Due to this, the same call may be queued in multiple queues based on multiple skills/problems that the customer (caller) may have. Accordingly, the present invention may reduce waiting time for customers.

Further, as the customer may be queued in multiple queues, this may improve agent utilization. For example, if a customer, who can speak both English and Spanish, waits in English queue (where the customer may be dealt in English language) then Spanish agents may sit idle. However, as in the present invention, the customer may be allowed to queue in multiple queues, both Spanish agents and English agents may have the customer. For example, if a Spanish agent is sitting idle then, as the customer may be allowed to queue in multiple queues, the customer may quickly get service from the Spanish agent instead of waiting for an English agent. Due to this, agent utilization may be increased as the Spanish agent may be required to serve the customer instead of sitting idle.

Furthermore, in one embodiment of the present invention, a customer may be serviced when the customer reaches an agent first via any of the two queues. Consequently, the customer's contact may be de-queued from the other queue so as to prevent duplicate serving to the customer from the multiple queues. This further adds on to throughput of a contact center.

Based on the aforementioned, it may be concluded that the present invention can provide an improvement in contact center throughput, agent utilization and customer service level.

These and other advantages will be apparent from the disclosure of the present invention(s) contained herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the present invention is considered to include a tangible storage medium or distribution medium and prior art-recognized equivalents and successor media, in which the software implementations of the present invention are stored.

The terms “determine”, “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the present invention is described in terms of exemplary embodiments, it should be appreciated those individual aspects of the present invention can be separately claimed.

The term “switch” or “server” as used herein should be understood to include a PBX, an ACD, an enterprise switch, or other type of communications system switch or server, as well as other types of processor-based communication control devices such as media servers, computers, adjuncts, etc.

The preceding is a simplified summary of the present invention to provide an understanding of some aspects of the present invention. This summary is neither an extensive nor exhaustive overview of the present invention and its various embodiments. It is intended neither to identify key or critical elements of the present invention nor to delineate the scope of the present invention but to present selected concepts of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of the present invention will become apparent upon consideration of the following detailed description of embodiments thereof, especially when taken in conjunction with the accompanying drawings wherein like reference numerals in the various figures are utilized to designate like components, and wherein:

FIG. 1 is a block diagram depicting a contact center according to an embodiment of the present invention;

FIG. 2 is a block diagram of a contact center system according to an embodiment of the present invention;

FIG. 3 depicts an exemplary block diagram to illustrate a mechanism for serving a contact (customer) according to an embodiment of the present invention;

FIGS. 4A and 4B collectively illustrate a flow diagram of a method for serving customers in a contact center according to one embodiment of the present invention;

FIGS. 5A and 5B collectively illustrate a flow diagram of a method for serving customers in a contact center according to another embodiment of the present invention; and

FIGS. 6A and 6B collectively depict a flow diagram of a method for serving customers in contact center according to yet another embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

The present invention will be illustrated below in conjunction with an exemplary communication system. Although well suited for use with, e.g., a system having an ACD or other similar contact processing switch, the present invention is not limited to any particular type of communication system switch or configuration of system elements. Those skilled in the art will recognize that the disclosed techniques may be used in any communication application in which it is desirable to provide improved contact processing.

FIG. 1 shows an illustrative embodiment of the present invention. A contact center 100 comprises a central server 110, a set of data stores or databases 114 containing contact or customer related information and other information that can enhance the value and efficiency of the contact processing, and a plurality of servers, namely a voice mail server 118, an Interactive Response unit (e.g., IVR) 122, and other servers 126, a switch 130, a plurality of working agents operating packet-switched (first) communication devices 134-1 to N (such as computer work stations or personal computers), and/or circuit-switched (second) communication devices 138-1 to M, all interconnected by a local area network LAN (or wide area network WAN) 142. The servers can be connected via optional communication lines 146 to the switch 130. As will be appreciated, the other servers 126 can also include a scanner (which is normally not connected to the switch 130 or Web server), VoIP software, video call software, voice messaging software, an IP voice server, a fax server, a web server, an email server, and the like. The switch 130 is connected via a plurality of trunks 150 to the Public Switch Telephone Network or PSTN 154 and via link(s) 152 to the second communication devices 138-1 to M. A gateway 158 is positioned between the server 110 and the packet-switched network 162 to process communications passing between the server 110 and the network 162.

Further, the gateway 158 can be, but is not limited to, Avaya Inc.'s, G700 Media Gateway™ and may be implemented as hardware such as via an adjunct processor or as a chip in the server.

The server 110 may be in communication with a plurality of customer communication lines (which can be one or more trunks, phone lines, etc.) and agent communication line (which can be a voice-and-data transmission line such as LAN 142 and/or a circuit switched voice line). The server 110 may include an operational contact center reporting module (not shown), such as, but not limited to, Avaya IQ™, CMS™, Basic Call Management System™, Operational Analyst™, and Customer Call Routing or CCR™ by Avaya, Inc., that may gather call records and contact-center statistics for use in generating contact-center reports.

The switch 130 and/or server 110 can be any architecture for directing contacts (customers) to one or more communication devices. In some embodiments, the switch 130 may perform load-balancing functions by allocating incoming or outgoing contacts among a plurality of logically and/or geographically distinct contact centers. Illustratively, the switch and/or server may be a modified form of the subscriber-78789.1 premises equipment sold by Avaya Inc. under the names Definity™ Private-Branch Exchange (PBX)-based ACD system, MultiVantage™ PBX, Communication Manager™, S8300™ media server and any other media servers, SIP Enabled Services™, Intelligent Presence Server™, and/or Avaya Interaction Center™, and any other products or solutions offered by Avaya or another company. Typically, the switch/server is a stored-program-controlled system that conventionally includes interfaces to external communication links, a communications switching fabric, service circuits (e.g., tone generators, announcement circuits, etc.), memory for storing control programs and data, and a processor (i.e., a computer) for executing the stored control programs to control the interfaces and the fabric and to provide automatic contact-distribution functionality. Other types of known switches and servers are well known in the art and therefore not described in detail herein.

The first communication devices 134-1, . . . 134-N are packet-switched and may include, for example, IP hardphones such as, but not limited to, the Avaya Inc.'s, 4600 Series IP Phones™, IP softphones such as Avaya Inc.'s, IP Softphone™, Personal Digital Assistants or PDAs, Personal Computers or PCs, laptops, packet-based H.320 video phones and conferencing units, packet-based voice messaging and response units, packet-based traditional computer telephony adjuncts, peer-to-peer based communication devices, and any other communication device.

The second communication devices 138-1, . . . 138-M are circuit-switched. Each of the communication devices 138-1, . . . 138-M may correspond to one of a set of internal extensions Ext1, . . . ExtM, respectively. The second communication devices may include, for example, wired and wireless telephones, PDAs, H.320 videophones and conferencing units, voice messaging and response units, traditional computer telephony adjuncts, and any other communication device.

It should be noted that the present invention does not require any particular type of information transport medium between switch or server and first and second communication devices, i.e., the present invention may be implemented with any desired type of transport medium as well as combinations of different types of transport channels.

The packet-switched network 162 can be any data and/or distributed processing network, such as the Internet. The network 162 typically includes proxies (not shown), registrars (not shown), and routers (not shown) for managing packet flows.

The packet-switched network 162 is in communication with a first communication device 174 via a gateway 178, and the circuit-switched network 154 with an external second communication device 180.

In a preferred configuration, the server 110, network 162, and first communication devices 134 are Session Initiation Protocol or SIP compatible and may include interfaces for various other protocols such as the Lightweight Directory Access Protocol or LDAP, H.248, H.323, Simple Mail Transfer Protocol or SMTP, IMAP4, ISDN, E1/T1, and analog line or trunk.

It should be emphasized that the configuration of the switch, server, user communication devices, and other elements as shown in FIG. 1 is for purposes of illustration only and should not be construed as limiting the present invention to any particular arrangement of elements.

Although the preferred embodiment is discussed with reference to a client-server architecture, it is to be understood that the principles of the present invention may apply to other network architectures. For example, the present invention applies to peer-to-peer networks, such as those envisioned by the Session Initiation Protocol. In the client-server model or paradigm, network services and the programs used by end users to access the services are described. The client side provides a user with an interface for requesting services from the network, and the server side is responsible for accepting user requests for services and providing the services transparent to the user. By contrast in the peer-to-peer model or paradigm, each networked host runs both the client and server parts of an application program. Additionally, the present invention does not require the presence of packet- or circuit-switched networks.

Referring to FIG. 2 that depicts a block diagram of a contact center system 200 according to an embodiment of the present invention. The contact center system 200 may be implemented in a contact center or Automatic Call Distribution (ACD). The contact center system 200 (hereinafter may be referred to as ‘the system 200’) may have a plurality of agents 204 for processing work requests from a plurality of queues in the contact center. As depicted, the contact center system 200 may include, but is not limited to, an interactive module 206 and a queuing module 208.

The interactive module 206 may interact with customers (contacts) for receiving information corresponding to work request of the customers. Specifically, if a customer has a query then the customer may call a contact center and may get routed to an IVR corresponding to the contact center. For example, a customer may dial a number of a destination (contact center) to connect with an IVR thereof. The interactive module 206 may further ask the customer for a language option of the customer and accordingly may receive primary input from the customer regarding choice of the customer that need to be considered for serving the customer. In a preferred embodiment of the present invention, such primary input of the customer may depict skills set of the customer and accordingly the system 200 may provide an agent from the plurality of agents 204 for serving the customer by processing a request of the customer.

Further, the interactive module 206 may identify an agent from the plurality of agents 204 based on the primary input that may be received from the customer. For example, if IVR of the contact center asks for language options from the customer then the customer may provide input regarding one suitable language for conversing with the customer to process a work request of the customer. Further, for example, if a customer requests the system 200 for resolving a query (hereinafter may be referred to as a ‘work request’) in English language then the system 200 may find an agent from an agent pool that converse (or process the work request) in English language. In an embodiment, the customer may be a registered contact of the system 200.

An agent pool based on the customer's request may be determined by the queuing module 208. Specifically, the queuing module 208 may add the customer (contact) in a work queue (such as a first work queue) of the plurality of work queues. The customer may be added in the work queue to process the work request of the customer. Further, if an agent from the determined agent pool is available then the customer may be served by the available agent by processing the work request received from the customer. Furthermore, if no agent is available for processing of the work request of the customer then the customer may be taken back to IVR. The interactive module 206 may communicate with the customer to ask if the customer knows any other language (other than the language selected by the customer while providing primary input to the interactive module 206). Further, the interactive module 206 may communicate with the customer to ask if the customer has any additional work request (other than the work request provided as the primary input by the customer).

Thus, while the customer is waiting in the first work queue for an availability of an agent for processing of the work request (primary input), the interactive module 206 may prompt the customer for providing one or more additional inputs corresponding to at least one of an additional skill or an additional work request of the customer. Further, based on the additional input provided by the customer, the queuing module 208 may add the contact in another work queue (such as a second work queue) related to another agent pool that may be able to serve the customer based on the additional inputs of the customer.

In one embodiment of the present invention, the additional input of the customer may include, but is not limited to, an additional skill such as an additional language that is known by the customer. Further, in another embodiment of the present invention, the additional input of the customer may include, but is not limited to an additional work request of the customer. For example, if the customer provides an additional input that the customer knows Spanish language (additional to the primary input for English language) then the queuing module 208 may add the contact of the customer in the second work queue having agents with proficiency in Spanish language. Similarly, if the additional input of the customer provides an additional work request then the queuing module 208 may add the contact of the customer in the second work queue having agents for processing of the additional work request. It may be appreciated by a person skilled in the art that by asking the customer for additional inputs, the system 200 may serve the customer in minimum required time instead of forcing the customer to wait in a queue for an agent from the same agent pool.

The customer is served when at least one agent from the plurality of agents is available through at least one of the first work queue and the second work queue. For example, in one embodiment, if the additional input provided by the customer includes additional language known by the customer then the customer may be served for the work request in any of the languages (such as English and Spanish, as inputted and known by the customer) through on any of the first work queue and the second work queue. After serving the client by processing the work request (primary) in any of the language and through any of the first work queue or the second work queue, contact may be de-queued from the other queue where no agent is made available to the customer. It may be noted that the contact may be de-queued as the work request may be processed in another language through another queue. Thus, this saves the customer's time that the customer otherwise may spent while waiting in queue for the agent to process the work request of the customer.

Similarly, in another embodiment, while the customer is waiting in a queue for processing of his/her primary request, the queuing module 208 may queue the customer in the second work queue for processing of the additional work request (i.e., another query) of the customer. For example, the customer is queued for various problems in different queues say queue ‘A’ and queue ‘B’. Further, in this embodiment, if the customer reaches to an agent in the queue ‘A’ then the contact will not be de-queued from other queue (queue ‘B’) as the work requests of the customer are different for both the queues (i.e., queue ‘A’ and queue ‘B’). Through this, the customer may be benefitted to save time by resolving an additional query while waiting for an agent to solve the primary query.

Further, if the contact reaches to head of the queue ‘B’ while the customer is talking to an agent in queue ‘A’, then an object corresponding to the contact (hereinafter may be referred to as ‘contact object’) in queue ‘B’ may be moved to as priority queue that may be associated with queue ‘B’. Again further, when the customer's conversation with the agent in queue ‘A’ is finished, the contact object that was moved to the priority queue earlier may be queued back (by the queuing module 208) to the head of the queue ‘B’ and may be made ready to reach the agent.

Herein, it may be noted that the primary query may be referred to as the query that may be provided before the additional query by the customer. Further, it may be appreciated by a person skilled in the art that the interactive module 206 may prompt the customer subsequently for one or more additional inputs regarding additional skills, additional query or any other input when the customer is waiting in a queue for availability of an agent for processing of the customer's query. Thus, a single customer may ask a plurality of queries or may know the response for a work request in a language of his/her choice while the customer is waiting for an agent in any queue.

It may be appreciated by a person skilled in the art that the system 200 is not limited to the modules, as described here-above. Further, various other modules may be implemented for performing functionality of the system 200. For example, the system 200 may include a database (not shown) for storing contact information of each customer (contact).

FIG. 3 depicts an exemplary block diagram to illustrate a mechanism for serving a contact (customer) according to an embodiment of the present invention. Specifically, FIG. 3 depicts a mechanism when the customer provides an additional work request to an IVR system while the customer is waiting in a queue for an agent for the processing of the work request (i.e., a primary work request of the customer).

As shown, a customer 302 may make a call using some Public Switched Telephone Network (PSTN) 304 to a call center. Further, the customer's call may land on a gateway 306 such as, but not limited to, Avaya Trunk Gateway (ATG). The gateway 306 may further deliver the call to a session manager 308 (such as, but not limited to, Avaya Aura Session Manager). Further, the session manager 308 may route the call to IVR 310 for customer self service. Herein, the self service of the customer may include, but not limited to, providing details like personal details, language, problem (work request) and the like. After completing the self service, the customer may opt to speak to an agent in a call center.

At this stage when the customer opts to speak to an agent then the experience portal (IVR) may contact Intelligent Customer Routing (hereinafter referred to as ‘ICR’) 312 to get optimal routing site of call center. The ICR 312 may contact a communication manager 314 where an agent may service to the customer call. The ICR 312 (or queuing module, such as the queuing module 208, as depicted in conjunction with FIG. 2) may place the customer 302 (caller) in a queue on the communication manager 314. The customer may remain in the queue on the communication manager 314 until an agent is available.

While the customer 302 is waiting in this queue, IVR 310 may ask the customer if he/she has any other query to be resolved. If the customer 302 says ‘yes’ then IVR again takes all inputs. While this is going on, the customer's contact is still waiting for an agent from an agent pool 316 corresponding to a first queue 318. Based on description of a second query of the customer 302, the customer 302 may be queued in a different queue by IVR for processing of the second query. Thereby, the customer 302 may be queued for various problems (work requests) in different queues say Q1 318 and a Q2 320.

Further, if the customer (contact) 302 reaches to an agent in Q1 318, here contact will not be de-queued from other queue (Q2 320). If the customer (contact) reaches to head of the Q2 320 while the customer is talking to agent in Q1 318, then a contact object corresponding to the customer in Q2 320 may be moved to a priority queue (PQ2) that is associated with Q2. Further, when the customer's conversation with agent in Q1 318 is finished, the contact object that was moved to the priority queue (PQ2) earlier may be queued back to the head of Q2 and thereby may be ready to land at agent of Q2. Further, when the agents are available, the customer may get connected with the agent to get service for request.

FIGS. 4A and 4B collectively illustrate a flow diagram of a method for serving customers in a contact center according to one embodiment of the present invention. The method depicted in FIGS. 4A and 4B (hereinafter may collectively be referred to as ‘FIG. 4’) corresponds to an IVR and queuing to allow customers to be queued in more than one queue while waiting for agent in a first queue. This may allow the same call to be queued in multiple queues based on multiple skills/problems that caller may have. The skills of the caller may include, but are not limited to, knowledge of multiple languages. Further, while waiting in multiple queues if contact is delivered to agent in one of the queues there may be two embodiments to handle the contact in multiple queues. The embodiments of the method (as depicted in FIG. 4) may be understood more clearly when read in conjunction with description of previous figures, such as FIGS. 1, 2 and 3. The order in which the method is performed is not intended to be construed as limitation, and further any number of the method steps may be combined in order to implement the method or an alternative method without departing from the scope of the present invention.

Specifically, as shown, at step 402, when a customer calls an IVR corresponding to a contact center, the IVR may prompt customer for inputs. Herein, the customer may be registered customer of the contact center. The inputs of the customer may correspond to choice of a language in which the customer may like to converse with any agent of the contact center.

Further, at step 404, IVR may route the call to a queue based on the customer's input. For example, if the customer's input includes information regarding a preferred language of the customer, say English then the IVR may route the call to an agent pool having a plurality of agents with proficiency in English language. Further, the call may be routed based on the type of the work request (problem) of the customer. For example, if the customer's query corresponds to an investment scheme then the agent pool where the customer is routed may deal in work related to investment scheme.

Further, at step 406, it may be determined if an agent from the agent pool is available for serving the customer. If it is determined that no agent is available for the customer then at step 408, the customer call may be kept in waiting for availability of an agent. Further, at step 410, IVR may prompt the customer for selection of other skills or problems that the user may want to resolve through an agent of the contact center. Accordingly, at step 412, it may be determined if the customer has any more problem in addition to a problem for which the customer is already waiting in a queue. If it is determined that the customer does not have any other problem (other than the problem for which the customer is waiting in the queue) then at step 414, the customer may wait in a queue or various queues in which the customer is already waiting until an agent is available in any one of the queues. Herein, the customer may wait until an agent is available in one of the queues for processing of the problem (work request) of the customer.

Further, at step 412, if it is determined that the customer has other additional problems then the method may resume at step 402 for prompting the customer for inputs. Accordingly, the process may follow again from 402 to 412 till the customer wants to provide additional choices while the customer is waiting in any of the queues of the contact center.

Further, from the step 414, when the contact (customer) waits in all the queues, until the agent is available for the customer in one of the queues, the method may proceed to step 416 (shown by a connector ‘A’) when an agent is available for the customer. Thus, at step 416, the customer's contact may be removed from all other queues (wherein the customer was waiting for agents in different languages) when the customer's query get resolved through an agent of one of the queues.

At step 418, the information about queues from which the customer was removed may be stored in a database for later use. Further, at step 420, the contact may be routed to the available agent (available at step 414). After completing the conversation (at step 422), it may be determined at step 424 if the contact (customer) was queued in multiple queues for any additional query. If it is determined that the contact was not queued in multiple queues then at step 426, the contact is ended after conversation is completed. Conversely, if it is determined at step 424 that the contact was queued in one or more queues for additional query or queries then at step 428, the customer may go back to IVR and at step 430, the customer may be able to choose if he/she wants to be queued for any other problem for which he was queued earlier and accordingly the pointer ‘B’ at step 430 may resume the method at step 414.

Further, at step 406, if it is determined that an agent is available then the method may resume to step 416 for removing the customer from all other queues when the customer is queued in other queues for the same problem and different language preferences.

FIGS. 5A and 5B collectively illustrate a flow diagram of a method for serving customers in a contact center according to another embodiment of the present invention. Hereinafter, FIGS. 5A and 5B may collectively be referred to as ‘FIG. 5’. Specifically, the method described in FIG. 5 corresponds to an embodiment implementing parallel queuing with de-queue on contact reaching agent. In this embodiment, the parallel queuing may be involved when the customer provides an additional input regarding additional known languages and may wait in other queues as well for receiving an agent for resolving the problem in any of the languages through any of the work queue.

The embodiments of the method (as depicted in FIG. 5) may be understood more clearly when read in conjunction with description of FIG. 4. Specifically, steps 502, 504, 506 and 508 are described previously in conjunction with steps 402 to 408 of FIG. 4 and thus not repeated here for the sake of brevity. Further, at step 510, the IVR may prompt the customer for selection of any other additional language for processing of the work request (problem) in such additional language. Accordingly, if the customer knows any additional language then the customer may choose that additional language so that the customer may be added in more than one queue for one problem. Due to this, the customer may enhance the chance of getting the agent at least in one of all the queues wherein the customer is queued. Further, the steps 512 and 514 are explained previously in conjunction with steps 412 and 414 of FIG. 4 and thus not repeated herein again for the sake of brevity.

Referring now to step 516 (in FIG. 5B), the agent may be made available in one of the languages pool wherein the customer was queued for the same problem. Further, at step 518, the customer may be removed from all other queues and at step 520; the customer's contact may be routed to the available agent to resolve the query of the customer. The order in which the method is performed is not intended to be construed as limitation, and further any number of the method steps may be combined in order to implement the method or an alternative method without departing from the scope of the present invention.

FIGS. 6A and 6B collectively depict a flow diagram of a method for serving customers in contact center according to yet another embodiment of the present invention. Hereinafter, FIGS. 6A and 6B may collectively be referred to as ‘FIG. 6’. Specifically, the method described in FIG. 6 corresponds to an embodiment implementing parallel queuing with priority queue. In this embodiment, the parallel queuing with priority queue may be involved when the customer provides an additional input regarding new additional query and may wait in other queues for receiving an agent for resolving the new additional query through a new agent pool.

The embodiments of the method (as depicted in FIG. 6) may be understood more clearly when read in conjunction with description of FIG. 5. The method of FIG. 6 may follow steps from 502 to 514 (of FIG. 5) for forming a group of queues in which a contact may be queued for different queries. Specifically, at step 602, an agent in one of the queues (say queue A) may become available then at step 604, the contact may be delivered to the agent in queue A. The customer contact may still be queued in all other queues as shown at step 606.

Further, at step 608, while the customer is still talking to agent in queue ‘A’, the same contact (customer) may reach to head of another queue (say queue ‘B’). At step 610, the contact may be moved to priority queue associated with queue ‘B’. The contact may remain in the priority queue till the customer continues talking to the agent of the queue ‘A’. Further at step 612, it may be determined if the customer's conversation with agent in queue ‘A’ is completed. If it is determined (at step 612) that the customer is still talking to the agent of the queue ‘A’ then the customer (contact) may remain in the priority queue (as depicted by ‘No’ pointer from step 612). Further, if at step 612, it is determined that the conversation with the agent in queue ‘A’ is completed then method may proceed to step 614 (as shown by pointer ‘A’ in FIG. 6B). At step 614, the contact may be moved back to the head of the queue ‘B’ and further at step 616, the contact may be delivered to the available agent of the queue ‘B’ to resolve the query (work request) corresponding to the queue ‘B’.

The order in which the method is performed is not intended to be construed as limitation, and further any number of the method steps may be combined in order to implement the method or an alternative method without departing from the scope of the present invention. It may be appreciated by a person skilled in the art that the embodiment of the method of the present invention may not be limited to the description of method FIGS. 4, 5, and 6. Further, various embodiments and steps may be implemented within the scope of the present invention. For example, the contacts' information may be stored along with their activities corresponding to selecting additional input for skills or additional problems (work requests). Additionally, a database may store information corresponding to various queues from which customer was removed intermediately.

The exemplary systems and methods of this present invention have been described in relation to a contact center. However, to avoid unnecessarily obscuring the present invention, the preceding description omits a number of known structures and devices. This omission is not to be construed as a limitation of the scope of the claimed invention. Specific details are set forth to provide an understanding of the present invention. It should however be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a switch, server, and/or adjunct, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the present invention.

A number of variations and modifications of the present invention can be used. It would be possible to provide for some features of the present invention without providing others.

For example in one alternative embodiment, the systems and methods of this present invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this present invention. Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, the present invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the present invention has been presented for purposes of illustration and description. The foregoing is not intended to limit the present invention to the form or forms disclosed herein. In the foregoing Detailed Description for example, various features of the present invention are grouped together in one or more embodiments, configurations, or aspects for the purpose of streamlining the disclosure. The features of the embodiments, configurations, or aspects of the present invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for serving a customer in a contact center having a plurality of agents for a plurality of work queues, the method comprising:
routing a customer call to a first work queue of the plurality of work queues based on a primary work request received from a customer;
receiving an intermediate input from the customer while the customer is waiting in the first work queue for processing of the primary work request, the intermediate input corresponds to at least one of skills and one or more additional work requests of the customer; and
adding the customer call to a second work queue of the plurality of work queues based on the intermediate input from the customer,
wherein the customer is served by processing at least one of the primary work request and the one or more additional work requests based on the intermediate input when at least one of the plurality of agents is available through at least one of the first work queue and the second work queue.

2. The method of claim 1 further comprising receiving an input prior to routing the customer call to the first work queue.

3. The method of claim 1, wherein the intermediate input is received to determine an additional language skill of the customer, the additional language skill determined for processing of the primary work request by an agent of the second work queue while the customer is waiting in the first work queue.

4. The method of claim 1, wherein the intermediate input comprises the one or more additional work requests, the customer call for the one or more additional work requests being queued in the second work queue simultaneous to queuing of the customer call for the primary work request in the first work queue.

5. The method of claim 1, wherein the primary work request is processed in different languages in the first work queue and the second work queue based on at least one of the skills of the customer.

6. The method of claim 1 further comprising determining position of a contact corresponding to the customer call in at least one of the first work queue and the second work queue to manage the contact by performing at least one of addition and deletion thereof in at least one of the first work queue, the second work queue and one or more queues of the plurality of work queues based on the intermediate input.

7. The method of claim 1 further comprising de-queuing the customer call from the first work queue when an agent is available for processing of the customer call in the second work queue, wherein the intermediate input of the customer correspond to at least one of the skills of the customer.

8. The method of claim 1 further comprising:
adding a contact of the customer in a priority queue when the contact reaches to a head of the first work queue of a plurality of work queues while the customer is being served in the second work queue of the plurality of queues; and
moving the contact from the priority queue to the first work queue when the customer is served in second work queue.

9. A contact center, comprising:
a plurality of work queues;
a plurality of agents for processing work requests from the plurality of work queues; and
a queuing module operable to add a contact of a customer in a first work queue of the plurality of work queues for processing of a work request received from the customer;
an interactive module to prompt the customer for receiving one or more inputs corresponding to at least one of an additional skill or an additional work request of the customer, while the customer is waiting in the first work queue for availability of an agent for processing of the work request; and
the queuing module further configured to add the contact of the customer in a second work queue of the plurality of queues for serving the customer by processing of at least one of the work request and the additional work request based on the one or more inputs received from the customer,
wherein the customer is served when at least one agent of the plurality of agents is available through at least one of the first work queue and the second work queue.

10. The contact center of claim 9, wherein the queuing module further operable to manage the contact of the customer in at least one of the first work queue, the second work queue and one or more other work queues of the plurality of work queues based on the one or more received inputs.

11. The contact center of claim 9, wherein, the queuing module operable to queue the contact in one or more queues subsequently based on the one or more inputs while the customer is waiting for an agent to process at least one of the work request and the additional work request of the customer.

12. The contact center of claim 9, wherein the queuing module further configured to de-queue the contact from one of the first work queue and the second work queues when an agent from the plurality of agents is available for processing of the work request in another queue of the first work queue and the second work queue, and wherein the one or more inputs of the customer correspond to the additional skill of the customer.

13. The contact center of claim 9, wherein the queuing module further operable to:
determine a position of the contact in at least one of the first work queue and the second work queue of the plurality of queues; and
manage the contact by performing at least one of deleting and adding the contact in at least one of the first work queue, the second work queue and one or more queues of the plurality of work queues based on the determined position of the contact,
wherein the contact is managed based on the one or more inputs of the customer.

14. The contact center of claim 9, wherein the queuing module operable to:
add the contact of the customer in a priority queue when the contact reaches to a head of the first work queue of a plurality of work queues while the customer is being served in the second work queue of the plurality of queues; and
manage the contact by moving the contact from the priority queue to the first work queue when the customer is served in second work queue.

15. The contact center of claim 9, wherein the interactive module is further configured to receive a preliminary input for enabling the queuing module to add the contact of the customer in the first work queue.

16. The contact center of claim 9, wherein the queuing module adds the contact in the second work queue for the additional work request simultaneous to queuing of the contact for the work request in the first work queue.

17. A method for serving a customer in a contact center having a plurality of work queues, the method comprising:
prompting the customer for receiving one or more inputs corresponding to an additional work request while the customer is waiting for availability of an agent in a first work queue for processing of a primary work request of the customer;
adding a contact of the customer in a second work queue for processing of the additional work request by an agent of the second work queue, wherein the contact is queued simultaneously in the first work queue and the second work queue;
adding the contact in a priority queue for a time while the customer is being served in the first work queue, and when the contact reaches to a head of the second work queue;
moving the contact from the priority queue to the second work queue when the customer is served in the first work queue, the contact is moved to the second work queue for serving the customer by processing the additional work request associated with the second work queue.

18. The method of claim 17 further comprising adding the contact of the customer in the first work queue for processing the primary work request prior to prompting the customer for receiving one or more inputs.

19. The method of claim 17 further comprising prompting the customer for receiving one or more inputs corresponding to a skill of the customer.

20. The method of claim 19 further comprising de-queuing the contact from one of the first work queue and the second work queue when the customer is serviced in another queue of the first work queue and the second work queue, and wherein the one or more inputs of the customer corresponds to the skill of the customer.
